(19) United States
(12) Patent Application Publication
(10) Pub. No.: US 2011/0297584 A1
(43) Pub. Date: Dec. 8, 2011

(54) SYSTEMS AND METHODS FOR PROCESSING A CATALYST REGENERATOR FLUE GAS

(76) Inventor: Ye Mon Chen, Sugar Land, TX (US)

(21) Appl. No.: 13/145,352

(22) PCT Filed: Dec. 17, 2009
(86) PCT No.: PCT/US09/68515

§ 371 Date: Aug. 4, 2011

Related U.S. Application Data
(60) Provisional application No. 61/146,520, filed on Jan. 22, 2009.

(51) Int. Cl. C10G 11/00; B01J 8/00

(52) U.S. Cl. 208/113; 422/187

(57) ABSTRACT

A system comprising a reactor comprising a hydrocarbon feedstock and a regenerated catalyst under catalytic cracking conditions to yield a cracked reactor product and a spent catalyst, the spent catalyst comprising a hydrocarbon layer; a regenerator comprising a spent catalyst feedstock and an oxygen containing gas feedstock to burn at least a portion of the hydrocarbon layer to regenerate the spent catalyst, the regenerator output comprising a first conduit comprising a regenerated catalyst, and a second conduit comprising a flue gas, the first and second conduits fluidly connected to the reactor; the second conduit fluidly connected to a heated oxygen containing gas source; and a mixing chamber fluidly connected to the second conduit comprising the flue gas.

### FIELD OF THE INVENTION

The present disclosure relates to systems and methods for processing a catalyst regenerator flue gas.

### BACKGROUND OF THE INVENTION

The fluidized catalytic cracking (FCC) of heavy hydrocarbons to produce lower boiling hydrocarbon products such as gasoline is well known in the art. FCC processes have been around since the 1940's. Typically, an FCC unit or process includes a riser reactor, a catalyst separator and stripper, and a regenerator. A FCC feedstock is introduced into the riser reactor wherein it is contacted with hot FCC catalyst from the regenerator. The mixture of the feedstock and FCC catalyst passes through the riser reactor and into the catalyst separator wherein the cracked product is separated from the FCC catalyst. The separated cracked product passes from the catalyst separator to a downstream separation system and the separated catalyst passes to the regenerator where the coke deposited on the FCC catalyst during the cracking reaction is burned off the catalyst to provide a regenerated catalyst. The resulting regenerated catalyst is used as the aforementioned hot FCC catalyst and is mixed with the FCC feedstock that is introduced into the riser reactor.

Some FCC regeneration units are operated in an incomplete mode of combustion, or partial combustion, defined by a CO content of from 1 to 6 volume percent. Substantially complete combustion of coke on an FCC molecular sieve catalyst is disclosed in Bertolacini et al U.S. Pat. No. 4,435,282, herein incorporated by reference in its entirety. This complete combustion exemplifies the type of system where the quantity of CO content is usually less than 500 ppm. The gaseous effluent from such a complete combustion regeneration unit has a low CO content and a high O₂ content (excess O₂).

U.S. Pat. No. 5,240,690 discloses a method for the addition of an oxygen-containing gas under certain defined process conditions, to an off-gas stream derived from an FCC regenerator which is operated in a partial mode of combustion. The off-gas from the regenerator contains 1-6% CO by volume and at least 80 ppm nitrogen compounds comprising mostly NH₃ and HCN. Without additional gas, roughly 20-40 percent of the NH₃ and HCN are converted to NOₓ in downstream CO boilers. One method disclosed is the addition of heated air (20% O₂) into the regenerator off gas to produce an off gas stream having a temperature of 1260° F. to 1500° F. U.S. Pat. No. 5,240,690 is herein incorporated by reference in its entirety.

U.S. Pat. No. 7,470,412 discloses a hot oxygen stream is fed into a catalyst regenerator flue gas stream that contains carbon monoxide to remove carbon monoxide. NOx precursors such as NH3 and HCN are converted into N2 and if NOx is present in the flue gas stream the addition of the hot oxygen stream lowers the amount of NOx present. U.S. Pat. No. 7,470,412 is herein incorporated by reference in its entirety.

There is a need in the art to lower the level of NOₓ in a regenerator flue gas.

There is a need in the art to lower the level of NOₓ in a FCC regenerator flue gas in a partial combustion mode.

There is a further need in the art to lower the level of NOₓ precursors in a regenerator flue gas.

There is a further need in the art to lower the level of CO in a regenerator flue gas.

There is a further need in the art to lower the level of CO in a FCC regenerator flue gas in a complete combustion mode.

There is a further need in the art to maximize the capacity of FCC units.

### SUMMARY OF THE INVENTION

In one aspect, the current invention provides a system comprising a reactor comprising a hydrocarbon feedstock and a regenerated catalyst under catalytic cracking conditions to yield a cracked reactor product and a spent catalyst, the spent catalyst comprising a hydrocarbon layer; a regenerator comprising a spent catalyst feedstock and an oxygen containing gas feedstock to burn at least a portion of the hydrocarbon layer to regenerate the spent catalyst, the regenerator output comprising a first conduit comprising a regenerated catalyst, and a second conduit comprising a flue gas, the first and second conduits fluidly connected to the reactor; the second conduit fluidly connected to a heated oxygen containing gas source; and a mixing chamber fluidly connected to the second conduit comprising the flue gas.

In another aspect, the current invention provides a method comprising catalytically cracking a hydrocarbon feedstock within a reactor zone by contacting under suitable catalytic cracking conditions within said reactor zone said hydrocarbon feedstock with a catalyst to yield a cracked reactor product comprising a cracked hydrocarbon product and a spent catalyst; passing said spent catalyst to a regenerator to burn a coke layer off of the spent catalyst to regenerate the catalyst and generate a flue gas; the regenerator operating in a total combustion mode so that the flue gas comprises at least 0.5% by volume of oxygen; adding a heated oxygen containing gas to the flue gas; and mixing the flue gas with the heated oxygen containing gas in a mixing chamber.

Advantages of the invention include one or more of the following:

Improved systems and methods for lowering the level of NOₓ in a regenerator flue gas.

Improved systems and methods for lowering the level of NOₓ precursors in a regenerator flue gas, for example in a partial combustion mode.

Improved systems and methods for lowering the level of CO in a regenerator flue gas, for example in a complete combustion mode.

Improved systems and methods to maximize the capacity of FCC units.

### BRIEF DESCRIPTION OF THE DRAWINGS

FIG. 1 illustrates a catalyst regenerator and flue gas treatment system.

FIGS. 2a & 2b illustrate a mixing device.

FIG. 3 illustrates a mixing device.

### DETAILED DESCRIPTION OF THE INVENTION

When hydrocarbon material is cracked to hydrocarbon material of shorter chain length, coke is produced as a by-product. In catalytic cracking, the coke forms a deposit on the cracking catalyst which necessitates regeneration of the cracking catalyst.

This regeneration is normally associated with burning the coke on the catalyst in an oxygen containing atmosphere. After coke has been removed from the surface of the catalyst, the catalyst is returned to the reactor to process other hydrocarbon materials to produce shorter hydrocarbon chains. The conversion of the coke on the surface of the burning catalyst results in formation of CO. The formation of CO in this manner is temperature dependent. If the temperature in the regenerator becomes hot enough, CO will convert to CO₂ in the presence of a sufficient amount of oxygen. In older FCC regeneration units, the CO is not immediately converted to CO₂, but instead must be converted to CO₂ in a subsequent downstream unit. This unfortunately has the disadvantage of forming NOₓ if nitrogen compounds, including NH₃ and HCN, are present in the feed gas to the CO combustion unit.

When the FCC regenerator is operated in a partial mode of combustion as much as 6000 ppm (or even more) ammonia and HCN can be present in the gaseous feed to the CO boiler. In addition, one to six percent CO is also present in the regeneration environment. Depending upon combustion conditions in the CO boiler, roughly 25 percent of the nitrogen compounds may be converted to NOₓ which is then subsequently emitted to the atmosphere unless very expensive scrubbing systems are employed to eliminate the NOₓ.

In one embodiment, a partial combustion flue gas composition contains from about 1 to about 7% (by volume) CO, from about 100 to about 500 ppm (by volume) O₂, a negligible level of NOₓ, from about 100 to about 1000 ppm (by volume) NOₓ precursors, for example HCN and NH₃.

When the FCC regenerator is operated in a partial mode of combustion, a sub-stoichiometric amount of oxygen is fed to the regenerator, which leads to less than full combustion of the carbon to CO₂ resulting in an increased amount of partial combustion and CO production. The flue gas thus has a low concentration of O₂ and a high concentration of CO. There may also be a relatively large amount of NOₓ precursors.

In contrast, when the FCC regenerator is operated in a complete mode of combustion, an excess stoichiometric amount of oxygen is fed to the regenerator, which leads to full combustion of the carbon to CO₂. The flue gas thus has a high concentration of O₂ and a low concentration of CO. There may also be a relatively large amount of NOₓ formed by the reaction of the NOₓ precursors with the excess oxygen.

In one embodiment, a full combustion flue gas composition contains from about 100 to about 1000 ppm (by volume) CO, from about 0.5% to about 5% (by volume) O₂, from about 15 to about 300 ppm (by volume) NOₓ, and negligible amounts of NOₓ precursors, for example HCN and NH₃.

In general, the larger the amount of excess O₂, the larger the amount NOₓ and the smaller amount of CO. Conversely, the smaller the amount of excess O₂, the smaller the amount NOₓ and the larger amount of CO.

The method of this invention utilizes an oxygen-containing gas, preferably air, and most preferably pre-heated air, as an injection gas into the regenerator exit flue gas. Depending upon the regeneration zone operating conditions, a large amount of the ammonia and/or HCN contained in the regeneration off gas can be converted into elemental nitrogen prior to entering the CO boilers by the use of this invention.

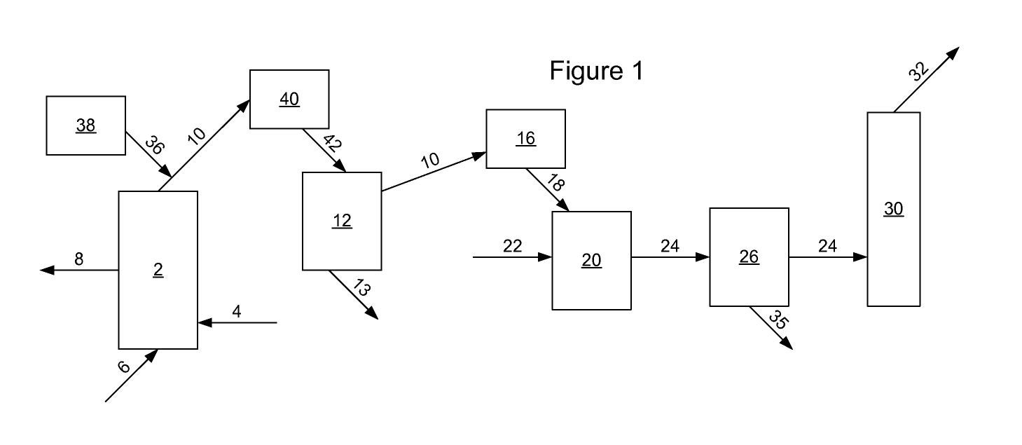

FIG. 1:

In FIG. 1, a catalytic reactor, for example a FCC unit, is operated to produce a spent catalytic cracking catalyst having carbon deposited on the surface of the catalyst. This spent catalyst is passed from the FCC reactor in conduit (4) to regenerator (2) to burn the carbon off the surface of the catalyst.

The oxidation of the coke on the catalyst occurs in the presence of an oxygen-containing gas added to the regenerator through conduit (6). After regeneration, the catalyst is returned to the FCC reactor through conduit (8). The off gas is removed from regenerator (2) through conduit (10). Air is pre-heated in preheater (38) and passed in cominglement with the regeneration off gas in conduit (10) via conduit (36).

Off gas and air is passed to mixing device 40, so that off gas can react with air to lower CO and/or NOₓ and/or other undesirable material levels in the off gas.

After mixing the admixture is passed to separation means (12) for the removal of catalyst fines. This catalyst removal can be made through horizontal or vertical cyclone separators. The removed catalyst particles are withdrawn from the process through conduit (13). Recovered gas is removed from separation means (12) in conduit (14) and passed to turbine power recovery unit (16) to maximize the amount of power recovered from the refinery stream possessing relatively high temperatures. After power has been recovered from stream (14), the cold or cooler gas is removed via conduit (18) and passed to the combustion zone (20) in which oxygen (for combustion of CO to CO₂) is added to combustion zone (20) through conduit (22). Any CO present in stream (18) is converted to CO₂ in combustion zone (20).

Combustion zone effluent is removed from combustion zone (20) in conduit (24) and passed to electrostatic precipitator (26) which is operated to remove any indigenous catalyst fines. The ultimate gaseous process effluent is passed to the atmosphere through gas stack (30) and conduit (32) while solids are removed through conduit (35).

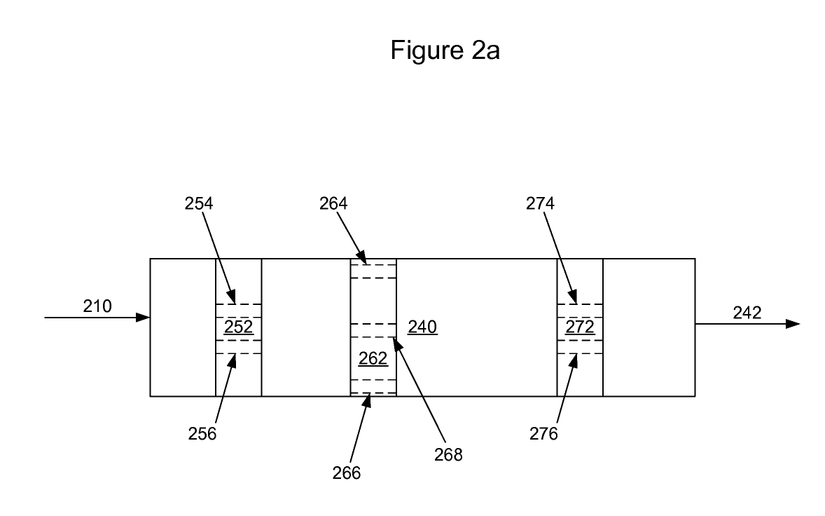

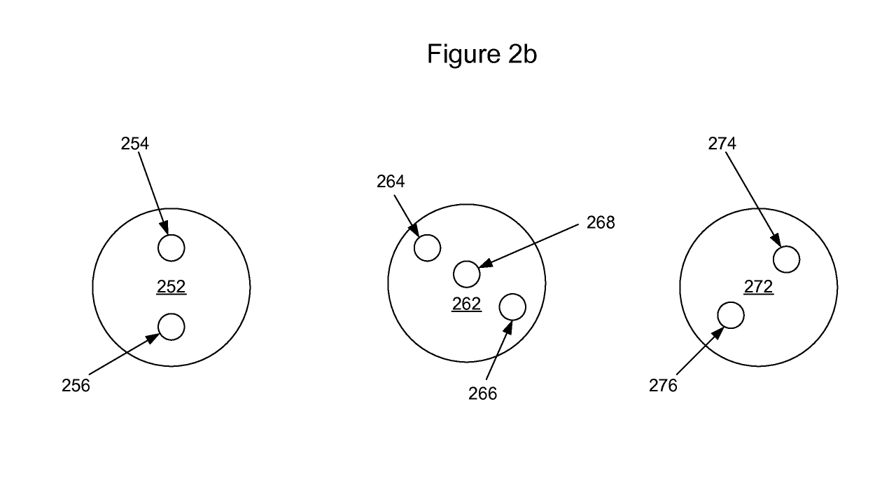

FIGS. 2a & 2b:

FIGS. 2a and 2b illustrate in somewhat greater detail mixing device 240. Conduit 210 provides an input of the mixture of flue gas and added air. In one embodiment, mixing device 240 is an orifice chamber. A plurality of plates 252, 262, and 272 are provided to mix flow 210 prior to being outputted to conduit 242.

Plate 252 has holes 254 and 256. Plate 262 has holes 264, 266, and 268. Plate 272 has holes 274 and 276. As shown in FIG. 2b, none of the holes in the plates align with each other along the length of mixing device 240 to enable better mixing.

In some embodiments, mixing device 240 may have from about 1 to about 10 plates, for example from about 2 to about 6 plates. Each plate may have from about 1 to about 10 holes, for example from about 2 to about 8 holes. The holes of each adjacent plate may be offset from each other, and not aligned along the length of mixing device 240.

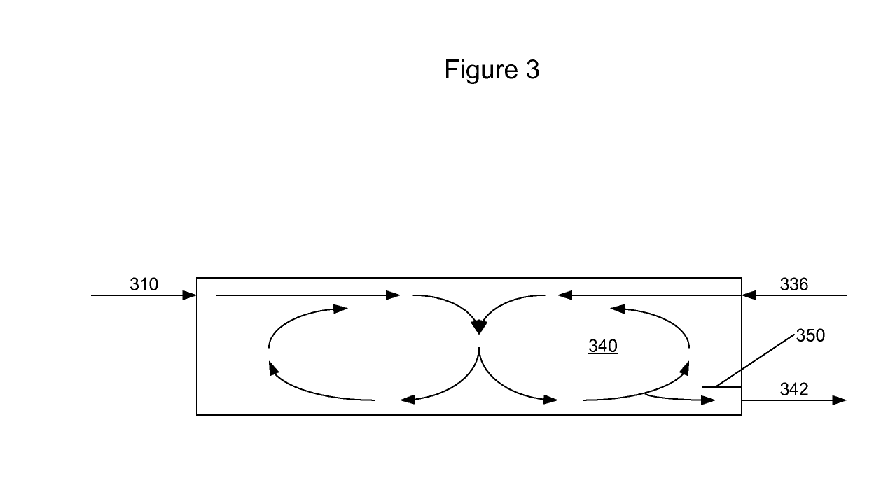

FIG. 3:

FIGS. 3a and 3b illustrate in somewhat greater detail mixing device 340. Conduit 310 provides an input of the flue gas from a catalyst regenerator and conduit 336 provides an input for added air from a preheater. In one embodiment, mixing device 340 is a counterflow mixing chamber. A plate 350 may be are provided to provide an outlet flow to output mixture to conduit 342.

In operation, flow 310 encounters flow 336 head on in the middle of mixing device 340, and creates swirl shaped flows and indicated by the arrows. A portion of the mixed swirl flow is taken off by plate 350 to output to conduit 342. The head on collision of flows 310 and 336 provides mixing of the flows.

### ILLUSTRATIVE EMBODIMENTS

In one embodiment of the invention, there is disclosed a system comprising a reactor comprising a hydrocarbon feedstock and a catalyst under catalytic cracking conditions to yield a cracked reactor product and a used catalyst, the used catalyst comprising a hydrocarbon layer; a regenerator comprising a used catalyst feedstock and an oxygen containing gas feedstock to burn at least a portion of the hydrocarbon layer to regenerate the used catalyst, the regenerator comprising an output of a regenerated catalyst from a first conduit and a flue gas from a second conduit; and a mixing chamber fluidly connected to the second conduit comprising the flue gas, and the mixing chamber fluidly connected to a heated oxygen containing gas source. In some embodiments, the mixing chamber comprises an orifice chamber. In some embodiments, the mixing chamber comprises a counterflow of the flue gas and the heated oxygen containing gas. In some embodiments, the system also includes a separator connected to the mixing chamber to separate solid catalyst particles from the flue gas and the heated oxygen containing gas mixture. In some embodiments, the regenerator comprises an amount of oxygen sufficient for a partial combustion mode. In some embodiments, the regenerator comprises an amount of oxygen sufficient for a total combustion mode.

In one embodiment of the invention, there is disclosed a method comprising catalytically cracking a hydrocarbon feedstock within a reactor zone by contacting under suitable catalytic cracking conditions within said reactor zone said hydrocarbon feedstock with a catalyst to yield a cracked reactor product comprising a cracked hydrocarbon product and a used catalyst; passing said used catalyst to a regenerator to burn a hydrocarbon off of the used catalyst to regenerated the catalyst and generate a flue gas; the regenerator operating in a total combustion mode so that the flue gas comprises at least 0.5% by volume of oxygen; and mixing the flue gas with a heated oxygen containing gas. In some embodiments, the mixing comprises passing the flue gas and the heated oxygen containing gas into an orifice chamber. In some embodiments, the flue gas comprises from 1% to 3% by volume of oxygen, and from 2% to 5% by volume of carbon monoxide. In some embodiments, the mixing the flue gas with a heated oxygen containing gas converts a portion of the carbon monoxide in the flue gas into carbon dioxide.

Those of skill in the art will appreciate that many modifications and variations are possible in terms of the disclosed embodiments of the invention, configurations, materials and methods without departing from their spirit and scope. Accordingly, the scope of the claims appended hereafter and their functional equivalents should not be limited by particular embodiments described and illustrated herein, as these are merely exemplary in nature.

1. A system comprising:
reactor means for receiving a hydrocarbon feedstock and a regenerated catalyst under catalytic cracking conditions to yield a cracked reactor product and a spent catalyst comprises a hydrocarbon layer;
regenerator means for receiving the spent catalyst and an oxygen containing gas and for burning at least a portion of the hydrocarbon layer to regenerate the spent catalyst, wherein regenerator means includes a first conduit fluidly connected to reactor means whereby regenerated spent catalyst passes to reactor means;
a second conduit
and mixing chamber means, wherein the second conduit is fluidly connected with the second conduit; and
wherein mixing chamber means comprises an orifice chamber.

2. (canceled)

3. The system of claim 1, wherein the mixing chamber comprises a counterflow of the flue gas and the heated oxygen containing gas.

4. The system of claim 1, further comprising a separator connected to the mixing chamber to separate solid catalyst particles from the flue gas and the heated oxygen containing gas mixture.

5. The system of claim 1, wherein the regenerator comprises an amount of oxygen sufficient for a partial combustion mode.

6. The system of claim 1, wherein the regenerator comprises an amount of oxygen sufficient for a total combustion mode.

7. A method comprising:
catalytically cracking a hydrocarbon feedstock within a reactor zone by contacting under suitable catalytic cracking conditions within said reactor zone said hydrocarbon feedstock with a catalyst to yield a cracked reactor product comprising a cracked hydrocarbon product and a spent catalyst;
passing said spent catalyst to a regenerator to burn a coke layer off of the spent catalyst to regenerate the catalyst and generate a flue gas; the regenerator operating in a total combustion mode so that the flue gas comprises at least 0.5% by volume of oxygen;
adding a heated oxygen containing gas to the flue gas; and
mixing the flue gas with the heated oxygen containing gas in a mixing chamber.

8. The method of claim 7, wherein the mixing comprises passing the flue gas and the heated oxygen containing gas into an orifice chamber.

9. The method of claim 7, wherein the flue gas comprises from 1% to 3% by volume of oxygen, and from 2% to 5% by volume of carbon monoxide.

10. The method of claim 7, wherein the mixing the flue gas with a heated oxygen containing gas converts a portion of the carbon monoxide in the flue gas into carbon dioxide.
